(19) United States
(12) Patent Application Publication
(10) Pub. No.: US 2002/0140287 A1
(43) Pub. Date: Oct. 3, 2002

(54) Wear guards for high drive type tractors

(76) Inventors: David M. Fee, Groveland, IL (US); Michael P. Larson, Metamora, IL (US); James W. Unruh, Peoria, IL (US)

Correspondence Address: CATERPILLAR INC., 100 N.E. ADAMS STREET, PATENT DEPT., PEORIA, IL, 616296490

(21) Appl. No.: 09/825,311

(22) Filed: Apr. 3, 2001

(51) Int. Cl. B62D 25/16

(52) U.S. Cl. 305/107

(57) ABSTRACT

A wear guard which prevents debris from entering a final drive assembly of a waste handling machine. The wear guard allows for easy inspection and cleaning of debris from the final drive assembly via an inspection port without the need for removing the entire drive assembly and other components. The wear guard is also designed to be installed on different types of final drive assemblies thus providing great design flexibility. This is provided via the use of spacers. The wear guard has a readily accessible lifting point requiring no special tooling. The wear guard also eliminates many of the distortion problems caused by welding while also reducing machining, dimension control and providing improved appearance.

### TECHNICAL FIELD

This invention relates generally to a wear guard and, more particularly, to a wear guard which prevents debris from entering a final drive assembly of a waste handling machine.

### BACKGROUND

Heavy machinery such as, for example, waste handling machinery, includes drive assemblies for driving the heavy machinery. These drive assemblies may include amongst other features roller frames, tracks, sprockets, a final drive and other components, all critical to the proper functioning and overall effectiveness of the heavy machinery. The final drive assembly, in turn, includes, hub assemblies, seals, spindles and rotator members which should be protected from debris, dirt and other refuse from entering the seals and wrapping around the rotator members and other components.

In waste management and similar applications, the waste handling machinery moves and, in particular, is used to manage the debris, waste and other garbage. It is thus especially important in these types of operations to maintain the integrity of the final drive assembly as well as other critical components during the operations of the waste handling machinery so as to maintain a high product level and hence efficient waste management operations.

However, in such an environment as a landfill, it is understandably difficult to maintain the waste handling machinery in efficient working order such as protecting the final drive assembly from debris entering the assembly. This is mainly due to the fact that waste handling machinery is persistently working in an environment with garbage and other debris which has a tendency to accumulate and wind around the final drive assembly. This garbage and debris may cause damage and wear to the rotator members, and can also enter and damage the seals (e.g., duo cone seal) which are fixed to the final drive. This, of course, can at the very least require extensive maintenance to clean the debris from the drive assembly and at the most allow oil to leak from the final drive assembly leading to catastrophic failure. In either case, the waste handling machinery must be periodically cleaned or repaired thus requiring many man hours, time and expense, all of which are borne by the operator.

In attempt to solve these problems, wear guards were developed for waste handling machinery used in waste management and similar applications. The wear guards prevent debris from accumulating in and wrapping around the final drive assembly thus providing significant improvement to the overall life of the final drive assembly and significantly eliminating costly downtime.

Current wear guards are fabricated from three separately manufactured components, e.g., (i) a ring, (ii) a tube and (iii) a plate, which all need to be cut, molded and welded together. However, the manufacturing processes for these components may be time intensive and require an inefficient use of material. Also, the heat from the welding process has a tendency to distort the tube and plate thus contributing to increased manufacturing costs and inadequate fittings. To eliminate this distortion requires the extensive use of fixtures to hold and maintain the shape of the wear guard during the welding process.

It is also noted that with the assembly of current wear guards, the wear guard must be specifically designed for a particular final drive assembly and is not flexible or suitable for mounting to another final drive assembly. That is, the ring portion must be an appropriate thickness in order to properly mount on a specifically final drive assembly. Also, field inspection using the current wear guards can only be accomplished by braking the track and removing the wear guards, themselves. Also, it is necessary to remove the entire wear guard and track (and possibly other components) in order to clean, repair or inspect the final drive assembly. This is typically a time consuming process which adds to the “down time” of the waste handling machine.

The present invention is directed to overcoming one or more of the problems as set forth above.

### SUMMARY OF THE INVENTION

In one aspect of the present invention, a wear guard has a central section having a first rim edge and a second rim edge. A first flange is seamlessly cast to the first rim edge and a second opposing flange is seamlessly cast to the second rim edge.

In another aspect of the present invention, a wear guard has an integrally formed central section and opposing first and second flange sections. A plurality of notches are formed in the second opposing flange section and spacers are mounted within the notches.

In another aspect of the present invention, a drive assembly has a hub and a sprocket mounted about the hub. A spindle is mounted to the hub and has a flange with a plurality of holes. A seal assembly is proximate to the hub. A wear guard is mounted about the spindle, and is at least a two component assembly forming a closed assembly about the spindle. The components of the wear guard have an integrally formed central section and opposing first and second flange sections. Notches are formed in the second opposing flange section and are aligned with selected holes of the spindle. Spacers are mounted within the notches and contact the flange.

### BRIEF DESCRIPTION OF THE DRAWINGS

FIG. 1 shows a front perspective view of a wear guard of the present invention;

FIG. 2 shows a top perspective view of two assembled wear guards; and

FIG. 3 shows a side plan view of the wear guard mounted to a final drive assembly.

### DETAILED DESCRIPTION

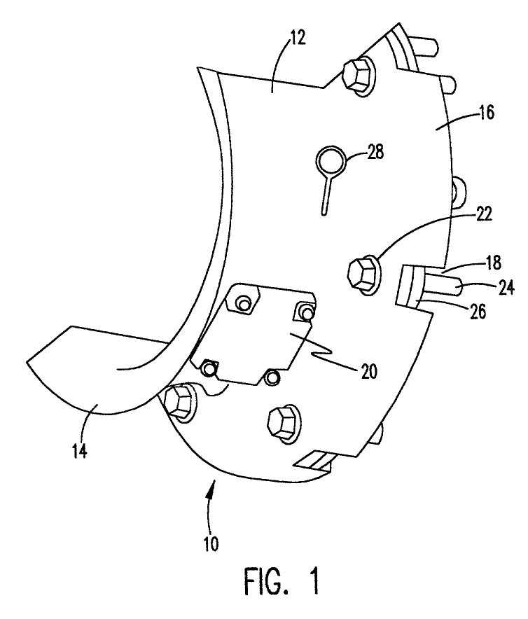

FIG. 1 shows a front perspective view of the wear guard of the present invention. The wear guard is generally depicted as reference numeral 10 and includes a central section 12 and opposing flanges 14 and 16. The central section 12 and the opposing flanges 14 and 16 are a seamlessly molded integral cast unit preferably made from cast ductile iron. The opposing flanges 14 and 16 are seamlessly cast to the central section 12 at rim edges thereof. An array of notches 18 is provided about a circumference of the flange 16. Also, an inspection port 20 is positioned within the central section 12.

Still referring to FIG. 1, fastener holes 22 are aligned with each of the notches 18, and a bolt or other appropriate fastener 24 is slidably mounted therethrough. In the preferred embodiment, four fastener holes 22 are provided on the flange 16. A spacer 26 is preferably positioned within each of the notches 18. It is noted that the spacers 18 may vary in thickness depending on the size of a particular final drive assembly. A lifting boss 28 is also mounted to the central section 12, preferably at the center of gravity of the entire wear guard 10.

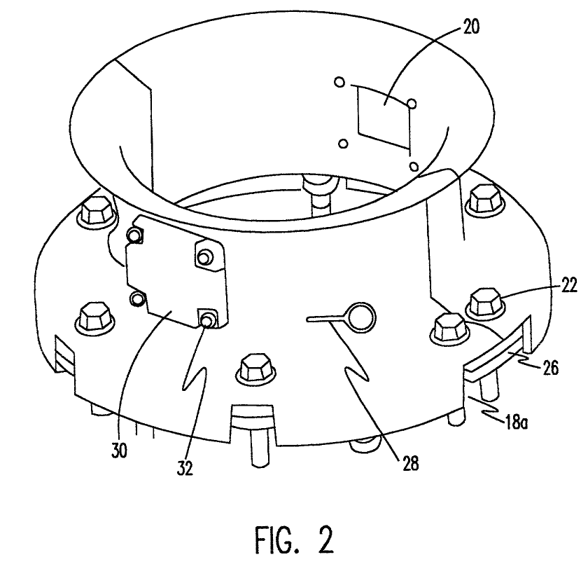

FIG. 2 shows a top perspective view of two assembled wear guards 10 which form a substantially closed assembly. As seen in this figure, a plate 30 is mounted over the inspection port 20 via bolts or other fasteners 32. Also, the end notches 18a, at the mating portion between the two assembled wear guards 10, are aligned with one another and form a wider opened section than the remaining notches 18. A spacer 26 of appropriate size and shape is fitted within the end notches 18a. It should be well understood by those of ordinary skill in the art that more than two wear guards 10 may be assembled to form a substantially closed assembly.

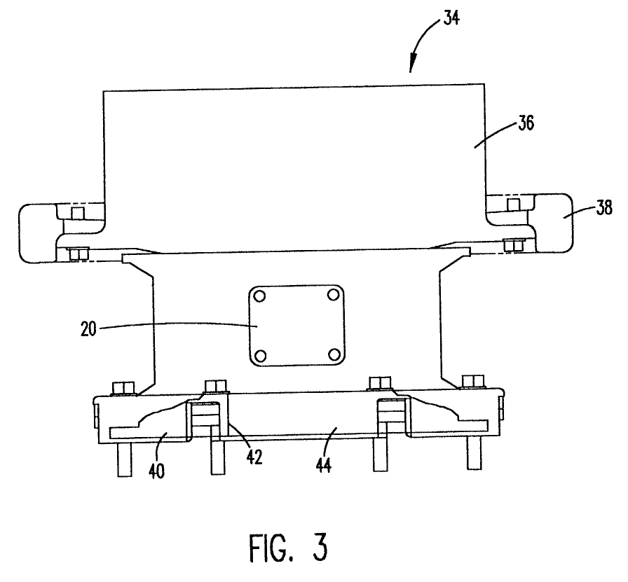

FIG. 3 shows a side plan view of the wear guard 10 of the present invention mounted to a final drive assembly. The final drive assembly is depicted as reference numeral 34 and includes a hub 36 and a sprocket 38. A spindle or rotator member 40 is mounted to the final drive assembly 34. The spindle 40 includes a plurality of holes 42, some of which correspond with the fastener holes 22 of the wear guard 10. The spindle 40 is attached to the machine (not shown). A seal assembly 44 is also provided about the final drive assembly 34. The wear guard 10 surrounds the spindle 40 (and seal assembly 44) and is mounted thereto via bolts or other fasteners extending through the corresponding holes 22 and 42 so as to be mounted to the machine.

### INDUSTRIAL APPLICABILITY

In use, the wear guards 10 of the present invention are mounted about the final drive assembly 34 of a machine. This is accomplished by first selecting appropriate thickness spacers 26 to place within the respective notches 18 and 18a of the wear guards 10. The spacers 26 are designed to allow the wear guards 10 to be installed on different types of spindles 40 without the need for increasing the thickness of the flange 16, itself. The spacers 26 should be selected so that there is approximately an 8 mm or 9 mm clearance between the wear guard 10 and the hub 36. Of course, other clearances are also contemplated for use with the present invention. Accordingly, the wear guards 10 of the present invention provide substantial flexibility by allowing mounting to different types of machines over one or more product line.

After the appropriate spacers 26 are selected and installed, the wear guard 10 is lifted via the centrally located lifting boss 28 mounted to the central tube section 12 of the wear guard 10. The lifting boss 28 provides a convenient mechanism for a readily accessible lifting point requiring no special tooling. Once properly positioned, the fastener holes 22 of the wear guard 10 are aligned with the holes 42 of the spindle 40. In this arrangement, there will be more holes 42 located on the spindle 40 than on the wear guard 10. Bolts or other fasteners are then positioned through the fastener holes 22 of the wear guard 10 and the holes 42 of the spindle 40 for mounting to the machine. The number of attachment fasteners per wear guard 10 is significantly reduced thus simplifying and improving assembly and maintenance of the wear guard 10 and final drive assembly 34. This same procedure is followed for the remaining wear guard 10 installations, i.e., until the wear guards 10 form a closed assembly about the spindle 40.

In the assembled form, the wear guards 10 prevent debris from wrapping around and damaging the rotator members and the seal area of the final drive assembly 34. Also, an operator can easily inspect the spindle and other components of the final drive assembly 34 by removing the plate 30 mounted over the inspection port 20. The operator may also remove any debris via these inspection ports 20. Inspection and cleaning can thus be accomplished without the need for removing the entire drive assembly and other components, including the track or wear guards 10, itself.

It is further noted that the use of a cast ductile iron eliminates many of the distortion problems caused by welding while also significantly reducing machining, dimension control and providing improved appearance of the wear guards 10. Abrasion resistance is also improved with the use of ductile iron castings.

Other aspects and features of the present invention can be obtained from a study of the drawings, the disclosure, and the appended claims.

What is claimed is:

1. A wear guard, comprising:
a central section having a first rim edge and a second rim edge;
a first flange seamlessly cast to the first rim edge of the central section; and
a second opposing flange seamlessly cast to the second rim edge of the central section,
wherein the central section, the first flange and the second opposing flange are an integral unit.

2. The wear guard of claim 1, wherein the central section, the first flange and the second opposing flange are integrally cast from cast ductile material.

3. The wear guard of claim 2, wherein the cast ductile material is ductile iron.

4. The wear guard of claim 1, including:
notches formed in the second opposing flange; and
spacers positioned within the notches.

5. The wear guard of claim 4, wherein the spacers vary in thickness.

6. The wear guard of claim 4, including fastener holes aligned within the notches.

7. The wear guard of claim 1, including an inspection port positioned within the central section.

8. The wear guard of claim 6, including a removable plate mounted over the inspection port.

9. The wear guard of claim 1, including a lifting boss mounted on the central section.

10. The wear guard of claim 9, wherein the lifting boss is located at a center of gravity of the wear guard.

11. A wear guard, comprising:
an integrally formed central section and opposing first and second flange sections;
a plurality of notches formed in the second opposing flange section; and
spacers mounted within the notches.

12. The wear guard of claim 11, including an inspection port within the central section.

13. The wear guard of claim 12, including a removable plate mounted over the inspection port.

14. The wear guard of claim 11, wherein the central section and the opposing first and second flange sections are cast ductile iron.

15. The wear guard of claim 11, wherein the spacers vary in thickness.

16. The wear guard of claim 11, including fastener holes aligned within the notches.

17. The wear guard of claim 11, including a lifting boss mounted on the central section.

18. A drive assembly, comprising:
a hub;
a sprocket mounted about the hub;
a spindle mounted to the hub adjacent the sprocket, the spindle including a flange having a plurality of holes;
a seal assembly proximate to the hub;
a wear guard mounted to and about the spindle, the wear guard being at least a two component assembly forming a closed assembly about the spindle, each of the components including,
a central section and integrally formed opposing first and second flange sections devoid of seams;
a plurality of notches formed in the second opposing flange section, the notches aligning with selected holes of the spindle; and
spacers mounted within the notches and contacting the flange of the spindle.

19. The drive assembly of claim 18, wherein the wear guard includes an inspection port within the central section.

20. The drive assembly of claim 18, wherein the wear guard includes fastener holes aligned within the selected holes of the spindle.

21. The drive assembly of claim 18, wherein the wear guard includes a lifting boss mounted on the central section.
